(19) United States
(12) Patent Application Publication
(10) Pub. No.: US 2016/0200191 A1
(43) Pub. Date: Jul. 14, 2016

(54) VEHICLE LOWER SECTION STRUCTURE

(71) Applicant: TOYOTA JIDOSHA KABUSHIKI KAISHA, Toyota-shi (JP)

(72) Inventors: Keita ITO, Aichi-gun (JP); Kenichiro YOSHIMOTO, Toukai-shi (JP)

(73) Assignee: TOYOTA JIDOSHA KABUSHIKI KAISHA, Toyota-shi (JP)

(21) Appl. No.: 14/989,384

(22) Filed: Jan. 6, 2016

(30) Foreign Application Priority Data
Jan. 14, 2015 (JP) 2015-005205

(51) Int. Cl. B60K 15/073; B62D 25/20

(52) U.S. Cl. CPC B60K 15/073; B62D 25/20; B60K 2015/03328

(57) ABSTRACT

A vehicle lower section structure comprising a floor tunnel that extends along a vehicle front-rear direction at substantially a vehicle width direction center of a floor panel; protruding sections that are attached to the floor panel, that extend along the vehicle front-rear direction or the vehicle width direction, and that project out toward the vehicle lower side; a tank band fastened to the protruding sections; a tank that is retained by a tank band in a state in which an upper portion of the tank is housed inside the floor tunnel; and first shock absorbing sections that are provided between the respective protruding sections and a lower portion of the tank, and each of that is configured to alleviate impact force acting on the tank from any one of the protruding sections that is displaced in the vehicle width direction due to collision load from a vehicle side direction.

### CROSS-REFERENCE TO RELATED APPLICATION

This application claims priority under 35 USC 119 from Japanese Patent Application No. 2015-005205 filed Jan. 14, 2015, the disclosure of which is incorporated by reference herein.

### BACKGROUND OF THE INVENTION

1. Technical Field

The present invention relates to a vehicle lower section structure.

2. Related Art

Japanese Patent Application Laid-Open (JP-A) No. H04-368227 describes an invention relating to a tank mounting structure in an automobile equipped with a hydrogen engine. Specifically, a center tunnel that opens toward the vehicle lower side is formed at substantially a vehicle width direction center portion of a floor panel, and a tank that is capable of storing hydrogen gas extends along the center tunnel in a space at the vehicle lower side of the center tunnel. The tank is configured to have high rigidity, and so providing the high rigidity tank at the vehicle center portion improves the rigidity of the entire vehicle body.

However, in the configuration described in JP-A No. H04-368227, the tank is formed with an attachment flange that extends along the vehicle width direction from a tank outer peripheral face toward the tank outside. The attachment flange is bolt-fastened to a floor reinforcement attached to the floor panel, thereby attaching the tank to the floor panel, and accordingly to the vehicle. Thus, when collision load from the vehicle width direction outside is input along the vehicle width direction in a vehicle side face collision (such a collision state is referred to below as a vehicle side-on collision), the collision load is directly input to the tank from the floor reinforcement. The tank itself therefore needs to have a strong configuration so as to withstand the impact force, such that there is room for improvement of the above related art from the perspective of lightening the weight and reducing the cost of the tank.

### SUMMARY

In consideration of the above circumstances, a subject of the present invention is to obtain a vehicle lower section structure capable of lightening the weight and reducing the cost of a tank.

A vehicle lower section structure of a first aspect of the present invention includes: a floor tunnel that extends along a vehicle front-rear direction at substantially a vehicle width direction center of a floor panel and that is open toward a vehicle lower side; protruding sections that are attached to the floor panel, that extend along the vehicle front-rear direction or the vehicle width direction, and that project out toward the vehicle lower side; a tank band fastened to the protruding sections; a tank that is retained by the tank band in a state in which an upper portion of the tank is housed inside the floor tunnel; and first shock absorbing sections that are provided between the respective protruding sections and a lower portion of the tank, and each of that is configured to alleviate impact force acting on the tank from any one of the protruding sections that is displaced in the vehicle width direction due to collision load from a vehicle side direction.

A vehicle lower section structure of a second aspect of the present invention is the vehicle lower section structure of the first aspect, wherein each of the first shock absorbing sections is provided with a shock absorbing member that absorbs the impact force.

A vehicle lower section structure of a third aspect of the present invention is the vehicle lower section structure of the first aspect or the second aspect, wherein: the tank band is configured divided into one band and another band; and one end portion of each of the bands is fastened to one of the protruding section, and the one band and the other band are installed separated from each other.

A vehicle lower section structure of a fourth aspect of the present invention includes: a floor tunnel that extends along a vehicle front-rear direction at substantially a vehicle width direction center of a floor panel and that is open toward a vehicle lower side; protruding sections that are attached to the floor panel, that extend along the vehicle front-rear direction or the vehicle width direction, and that project out toward the vehicle lower side; a tank band fastened to the protruding sections; a tank that is retained by the tank band in a state in which an upper portion of the tank is housed inside the floor tunnel; and a second shock absorbing section that is formed to a portion of the tank band, and that is configured to alleviate impact force acting on the tank from any one of the protruding section that is displaced in the vehicle width direction due to collision load from a vehicle side direction.

A vehicle lower section structure of a fifth aspect of the present invention is the vehicle lower section structure of any one of the first aspect to the fourth aspect, wherein the tank band is provided with a tank support portion that abuts the tank and that is formed in substantially the same shape as an outside face of the tank at the abutted location.

A vehicle lower section structure of a sixth aspect of the present invention is the vehicle lower section structure of any one of the first aspect to the fifth aspect, wherein a tank protection plate formed in a plate shape is provided at the vehicle lower side of the tank and the tank band so as to cover the tank from at least the vehicle lower side.

A vehicle lower section structure of a seventh aspect of the present invention is the vehicle lower section structure of the sixth aspect, wherein the tank protection plate is configured by an inner panel that supports the tank, and an outer panel that is disposed separated from the inner panel at the vehicle lower side of the inner panel.

A vehicle lower section structure of an eighth aspect of the present invention is the vehicle lower section structure of any one of the first aspect to the fourth aspect, further including a tank support member that is provided between the tank band and the tank, wherein the tank support member is formed with a tank support portion that abuts the tank and is formed in substantially the same shape as an outside face of the tank at the abutted location.

In the first aspect, the first shock absorbing sections are provided between the tank housed inside the floor tunnel and the protruding sections attached to the floor panel. Generally, in a vehicle side-on collision, when collision load along the vehicle width direction from the vehicle width direction outside is input to the floor panel, the floor panel and the protruding section attached to the floor panel are displaced along the vehicle width direction and abut the tank. Impact force from the protruding section thereby acts on the tank. However, in the present aspect, the impact force acting on the tank from the protruding section can be alleviated by the first shock absorbing section. This enables an impact resistant structure of the tank to have a simple structure.

In the second aspect, the shock absorbing member is provided at each of the first shock absorbing sections, thereby enabling impact force acting on the tank from the protruding section in a vehicle side-on collision to be further alleviated. This enables the impact resistant structure of the tank to be improved.

In the third aspect, the tank band is configured by the one band and the other band, and the one band and the other band are separated from each other. This enables variations in dimensions and variations in assembly of the tank band and the floor panel, etc. to be adjustable in this separated space.

In the fourth aspect, the second shock absorbing section formed at the tank band is included in a range between each of the protruding sections attached to the floor panel and the tank. Generally, in a vehicle side-on collision, when collision load along the vehicle width direction from the vehicle width direction outside is input to the floor panel, the floor panel and the protruding section attached to the floor panel are displaced along the vehicle width direction. Impact force from the protruding section thereby acts on the tank. However, in the present aspect, the impact force acting on the tank from the protruding section can be alleviated by the second shock absorbing section. This enables the impact resistant structure of the tank to have a simple structure.

In the fifth aspect, the tank support portion that is formed in substantially the same shape as the outside face of the tank supports the tank, such that the tank and the tank support portion are in constant contact with each other. This enables the tank to be retained in a specific position, and enables the tank to be stably supported, thereby enabling the tank to be suppressed from vibrating. This enables impact force acting on the tank due to vibration to be alleviated, thereby enabling the impact resistant structure of the tank to be improved.

In the sixth aspect, the tank is covered from the vehicle lower side by the tank protection plate, such that impact force input to the vehicle from the vehicle lower side by an obstacle or the like is input to the tank protection plate. Namely, the impact force from the vehicle lower side is less liable to be directly transmitted to the tank, and can be alleviated by the tank protection plate.

In the seventh aspect, a region surrounded by the inner panel and the outer panel can be configured as a deformation absorption section. Thus, even if the tank protection plate deforms so as to project out toward the vehicle upper side due to impact force input to the vehicle from the vehicle lower side by an obstacle or the like, the tank protection plate and the tank are suppressed from abutting each other by the deformation absorption section, thereby enabling the impact force acting on the tank from the tank protection plate to be alleviated.

In the eighth aspect, the tank support member is provided between the tank band and the tank, and the tank support portion that is formed in substantially the same shape as the outside face of the tank is formed at the tank support member and supports the tank. Thus the tank and the tank support portion are in constant contact. This enables the tank to be retained in a specific position, and enables the tank to be stably supported, thereby enabling the tank to be suppressed from vibrating. This enables impact force acting on the tank due to vibration to be alleviated, thereby enabling the impact resistant structure of the tank to be improved.

The vehicle lower section structure of the first aspect, second aspect, and fourth to eighth aspects has excellent advantageous effects of enabling the tank to have a lighter weight and a lower cost.

The vehicle lower section structure of the third aspect has an excellent advantageous effect of enabling assembly performance of the tank to the floor panel to be improved.

### BRIEF DESCRIPTION OF THE DRAWINGS

Embodiments of the present aspect will be described in detail based on the following figures, wherein:

FIG. 1 is an exploded perspective view illustrating a floor panel including a vehicle lower section structure according to a first exemplary embodiment, in a state viewed from the vehicle rear toward the vehicle front;

FIG. 2A is a cross-section illustrating a vehicle provided with a vehicle lower section structure according to a Comparative Example;

FIG. 2B is a cross-section corresponding to FIG. 2A, illustrating a vehicle provided with a vehicle lower section structure according to the first exemplary embodiment;

FIG. 3A is a cross-section illustrating a state in which a tank band is attached to floor reinforcements, in a vehicle lower section structure according to the first exemplary embodiment;

FIG. 3B is a cross-section illustrating a state in which a tank band is attached to floor cross members, in a vehicle lower section structure according to the first exemplary embodiment;

FIG. 4 is a cross-section of a vehicle lower section structure according to a modified example of the first exemplary embodiment, viewed from in front of the vehicle;

FIG. 5 is a cross-section illustrating a state in which a tank band is attached to floor reinforcements, in a vehicle lower section structure according to a second exemplary embodiment;

FIG. 6 is a cross-section illustrating a state in which a tank band is attached to floor reinforcements, in a vehicle lower section structure according to a third exemplary embodiment;

FIG. 7A is a cross-section illustrating a state in which a tank band is attached to floor reinforcements, in a vehicle lower section structure according to a fourth exemplary embodiment;

FIG. 7B is an enlarged perspective view illustrating the tank band in FIG. 7A;

FIG. 8A is a cross-section illustrating a state in which a tank retaining member configured of two components is provided to a tank band in a vehicle lower section structure according to a modified example of the fourth exemplary embodiment;

FIG. 8B is a cross-section illustrating a state in which a tank retaining member configured of one component is provided to a tank band in a vehicle lower section structure according to a modified example of the fourth exemplary embodiment;

FIG. 9A is a cross-section illustrating a state in which a tank band is attached to floor reinforcements, in a vehicle lower section structure according to a fifth exemplary embodiment;

FIG. 9B is a cross-section illustrating a state in which a tank band is attached to floor cross members, in a vehicle lower section structure according to the fifth exemplary embodiment;

FIG. 10A is an enlarged cross-section illustrating a second shock absorbing section of a tank band in a vehicle lower section structure according to a modified example of the fifth exemplary embodiment;

FIG. 10B is an enlarged cross-section corresponding to FIG. 10A, illustrating yet another modified example;

FIG. 11A is a cross-section illustrating a state in which a tank retaining member configured of two components is provided to a tank band in a vehicle lower section structure according to a sixth exemplary embodiment;

FIG. 11B is a cross-section illustrating a state in which a tank retaining member configured of one component is provided to a tank band in a vehicle lower section structure according to the sixth exemplary embodiment;

FIG. 12 is a cross-section illustrating a state in which a tank band is attached to floor cross members, in a vehicle lower section structure according to a seventh exemplary embodiment;

FIG. 13 is an exploded perspective view illustrating a floor panel provided with a vehicle lower section structure according to an eighth exemplary embodiment, in a state viewed from the vehicle rear toward the vehicle front;

FIG. 14A is a cross-section illustrating a normal state in a vehicle lower section structure according to the eighth exemplary embodiment, viewed from in front of the vehicle;

FIG. 14B is a cross-section illustrating a normal state in a vehicle lower section structure according to the eighth exemplary embodiment at a position where a tank band is attached, viewed from in front of the vehicle;

FIG. 14C is a cross-section illustrating a state during deformation of a tank protection plate in a vehicle lower section structure according to the eighth exemplary embodiment;

FIG. 15A is a cross-section illustrating a vehicle lower section structure according to the eighth exemplary embodiment, viewed from a vehicle side face;

FIG. 15B is an enlarged cross-section at section Z in FIG. 15A;

FIG. 15C is an enlarged cross-section at section Yin FIG. 15A;

FIG. 16A is a cross-section illustrating a vehicle lower section structure according to a first modified example of the eighth exemplary embodiment, viewed from a vehicle side face;

FIG. 16B is a cross-section illustrating a second modified example of the eighth exemplary embodiment;

FIG. 16C is a cross-section illustrating a third modified example of the eighth exemplary embodiment;

FIG. 16D is a cross-section illustrating a fourth modified example of the eighth exemplary embodiment;

FIG. 17A is a cross-section illustrating a vehicle lower section structure according to a ninth exemplary embodiment, viewed from in front of the vehicle;

FIG. 17B is a cross-section illustrating a first modified example of a vehicle lower section structure according to the ninth exemplary embodiment;

FIG. 17C is a cross-section illustrating a second modified example of a vehicle lower section structure according to the ninth exemplary embodiment; and

FIG. 17D is a cross-section illustrating a third modified example of a vehicle lower section structure according to the ninth exemplary embodiment.

### DETAILED DESCRIPTION OF THE INVENTION

### First Exemplary Embodiment

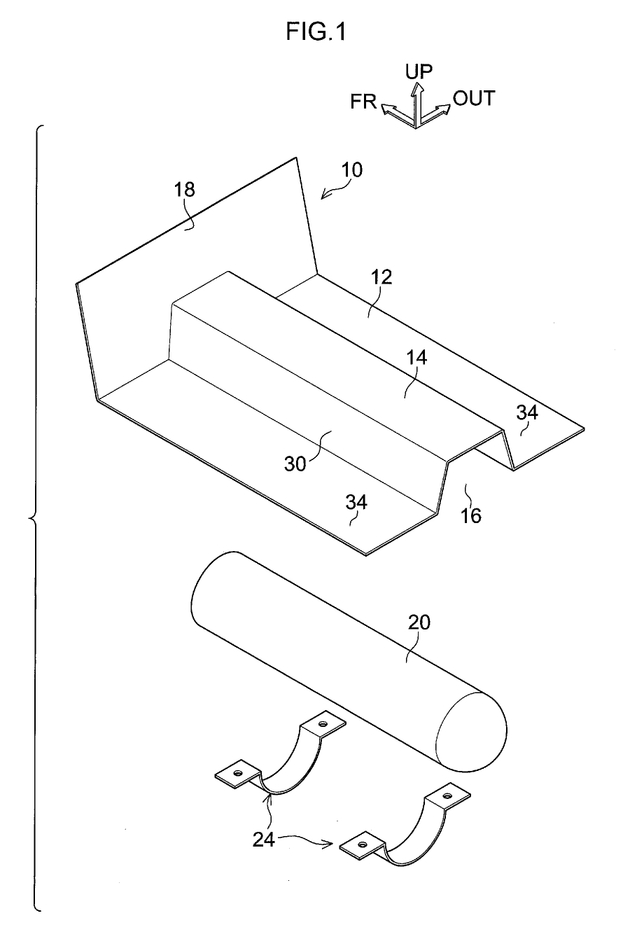

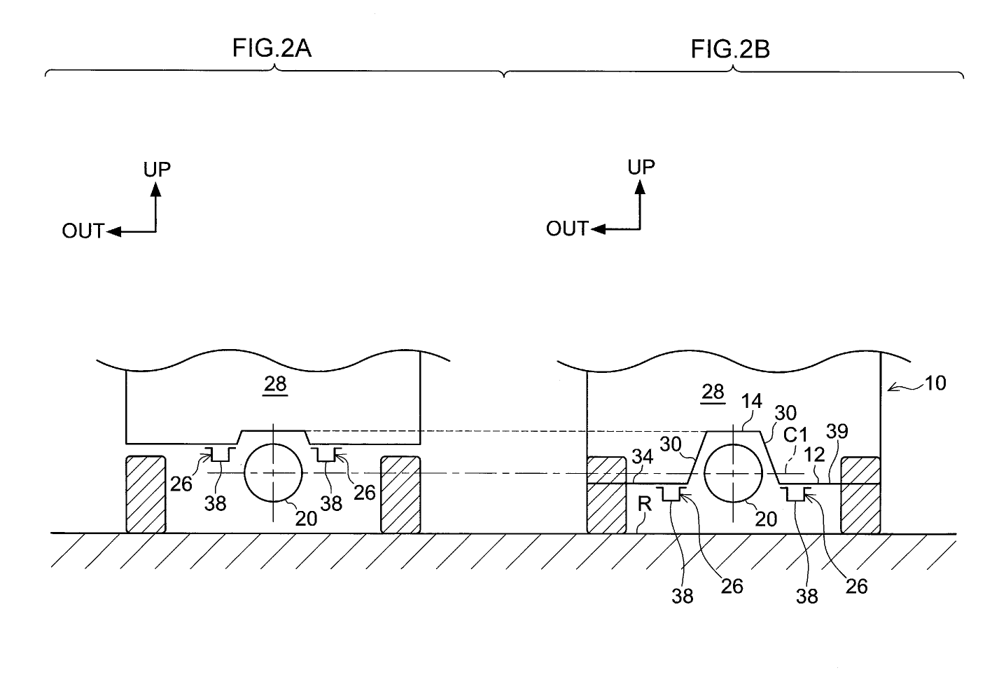

Explanation follows regarding a first exemplary embodiment of a vehicle lower section structure according to the present invention, with reference to FIG. 1 to FIG. 2B. Note that in the drawings, the arrow FR indicates the vehicle front-rear direction front side, the arrow OUT indicates the vehicle width direction outside, and the arrow UP indicates the vehicle up-down direction upper side, respectively.

As illustrated in FIG. 1, a floor tunnel 14 is formed at substantially the vehicle width direction center of a floor panel 12 configuring a lower section of a vehicle 10. The floor tunnel 14 is formed with a cross-section profile orthogonal to the vehicle front-rear direction in an inverted U-shape, and with an opening 16 at the vehicle lower side. The floor tunnel 14 extends along the vehicle front-rear direction from a dash panel 18 provided at a front end of the floor panel 12 across to a rear end portion of the floor panel 12. Note that, although the floor tunnel 14 is formed at substantially the vehicle width direction center of the floor panel 12 in the present exemplary embodiment, the floor tunnel 14 may be formed at a position that is slightly offset from the vehicle width direction center.

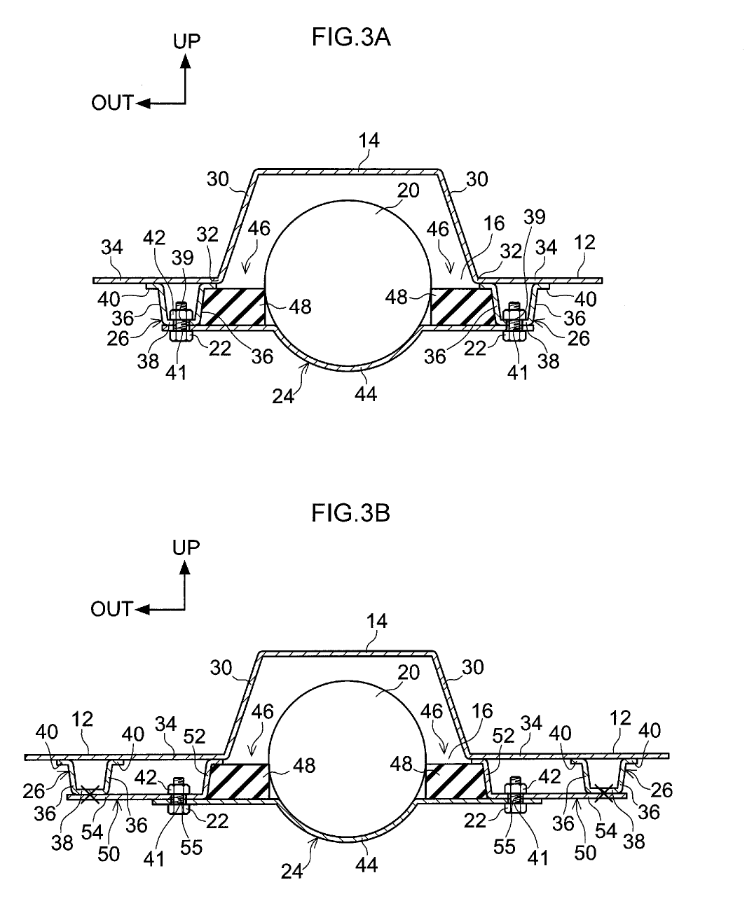

A hydrogen tank 20, serving as a tank, is housed inside the floor tunnel 14 at the vehicle lower side of the floor tunnel 14 (see FIG. 3). The hydrogen tank 20 is formed in a substantially circular tube shape with its axis along the vehicle front-rear direction, and both vehicle front-rear direction ends are closed off by end portions, each formed in a substantially semi-spherical shape. The interior of the hydrogen tank 20 is thereby configured as a sealed structure capable of being filled with hydrogen. The hydrogen tank 20 is supported from the vehicle lower side by plural tank bands 24 provided at the vehicle lower side of the hydrogen tank 20. Each tank band 24 is formed in a substantially rectangular shape in plan view, and has both length direction end portions fastened to the floor panel 12 side by bolts 22 (see FIGS. 3), or the like.

A portion of the hydrogen tank 20 excluding a lower portion is housed inside the floor tunnel 14. As illustrated in FIG. 2B, a vehicle up-down direction center C1 of the hydrogen tank 20 is disposed further to the upper side than reinforcement bottom wall portions 38 of floor reinforcements 26, described later, that is joined to the floor panel 12. The vehicle up-down direction height of the hydrogen tank 20 is set at a specific height so as to avoid interference with obstacles or the like on a road surface R. Namely, the floor is set taking a space for the hydrogen tank 20 into consideration. Thus, in the present exemplary embodiment, a vehicle up-down direction height dimension of the floor tunnel 14 is increased, and a vehicle lower side face of the floor panel 12 is disposed further to the vehicle lower side than a configuration in which the vehicle up-down direction center of the hydrogen tank 20 is disposed further to the lower side than the reinforcement bottom wall portions 38 of the floor reinforcements 26, as illustrated in FIG. 2A. A space 28 inside a vehicle cabin is thereby enlarged. Moreover, side wall portions 30 of the floor tunnel 14 are disposed at the vehicle width direction outside of the hydrogen tank 20, such that a range over which the hydrogen tank 20 is covered by the floor tunnel 14 is increased, thereby enabling impact force acting on the hydrogen tank 20 in a vehicle side-on collision to be alleviated. Furthermore, by increasing the vehicle up-down direction height dimension of the floor tunnel 14, the rigidity of the floor tunnel 14 is improved, and collision load acting on the floor panel 12 in a vehicle head-on collision is concentrated at the floor tunnel 14. This alleviates the input of collision load to the hydrogen tank 20.

As illustrated in FIG. 3A, each floor reinforcement 26, serving as a protruding section, is joined to an end portion of the opening 16 of the floor tunnel 14, namely, in the vicinity of a joint portion between a vehicle lower side end portion 32 of the floor tunnel 14 and a lower wall portion 34 of the floor panel 12. A cross-section of the floor reinforcement 26 orthogonal to the vehicle front-rear direction is formed in a substantially U-shape, including a pair of reinforcement upright wall portions 36 extending substantially along the vehicle up-down direction, and the reinforcement bottom wall portion 38 that links between respective vehicle lower side end portions of the reinforcement upright wall portions 36. The floor reinforcement 26 extends substantially in the vehicle front-rear direction along the floor tunnel 14. Flange portions 40, which each extend along the vehicle width direction in directions moving away from each other, are provided at vehicle upper side end portions of the respective reinforcement upright wall portions 36, and the flange portions 40 are joined to the floor panel 12. The floor reinforcement 26 is thereby joined to the floor panel 12.

The reinforcement bottom wall portion 38 of the floor reinforcement 26 is formed with a reinforcement fastening hole 39 piercing through in the plate thickness direction. The bolt 22 is inserted through the reinforcement fastening hole 39 and a band cross fastening hole 41 formed piercing through each end portion of the tank bands 24 in the plate thickness direction, and the bolt 22 is fastened to a nut 42. The tank bands 24 are thereby fastened to the floor panel 12 via the floor reinforcements 26. Note that in each tank band 24, a tank abutting portion 44 that abuts the vehicle lower side of the hydrogen tank 20 and serves as a tank support portion has substantially the same shape as the shape at an abutted portion of an outer peripheral face of the hydrogen tank 20.

A first shock absorbing section 46 is provided between the reinforcement upright wall portion 36 at the vehicle inside of the floor reinforcement 26 at a location at which the tank bands 24 are provided, and an outside face of the hydrogen tank 20. In the present exemplary embodiment, a shock absorbing member 48 is provided at the first shock absorbing section 46. The shock absorbing member 48 is a rubber block, and is attached to the reinforcement upright wall portion 36 at the vehicle inside of the floor reinforcement 26. Note that the shock absorbing member 48 is provided at the vehicle upper side of the tank bands 24, thereby suppressing the shock absorbing members 48 from falling toward the vehicle lower side. In the present exemplary embodiment, each shock absorbing member 48 is a rubber block; however, configuration is not limited thereto, and the shock absorbing member 48 may be configured of another material such as aluminum alloy, and may have a mesh structure or a honeycomb structure.

As illustrated in FIG. 3B, in cases in which the tank band 24 is attached at a location where floor cross members 50, serving as a protruding section, are provided, the tank band 24 is fastened to the floor cross members 50. Specifically, a cross-section profile of each floor cross member 50 orthogonal to the vehicle front-rear direction is formed in substantially an L-shape, by a member upright wall portion 52, and a member bottom wall portion 54 extending along the vehicle width direction from a vehicle lower side end portion of the member upright wall portion 52. A vehicle width direction outside end portion of the member bottom wall portion 54 is joined by welding to the reinforcement bottom wall portion 38 of the floor reinforcement 26 from the vehicle lower side, and a vehicle upper side end portion of the member upright wall portion 52 is joined to the end portion of the opening 16 of the floor tunnel 14. The floor cross member 50 is thereby joined to the floor panel 12.

The member bottom wall portion 54 of the floor cross member 50 is formed with a member fastening hole 55 formed piercing through in the plate thickness direction. The bolt 22 is inserted through the member fastening hole 55 and the band cross fastening hole 41 piercing through either end of the tank band 24 in the plate thickness direction, and the bolt 22 is fastened by the nut 42, thereby fastening the tank band 24 to the floor panel 12 via the floor cross member 50.

The first shock absorbing section 46 is provided between the member upright wall portion 52 at the vehicle inside of the floor cross member 50 at the location at which the tank band 24 is provided, and the outside face of the hydrogen tank 20. The first shock absorbing section 46 is provided with the shock absorbing member 48, similarly to as previously described. The shock absorbing member 48 is provided at the vehicle upper side of the tank band 24, thereby suppressing the shock absorbing member 48 from falling toward the vehicle lower side.

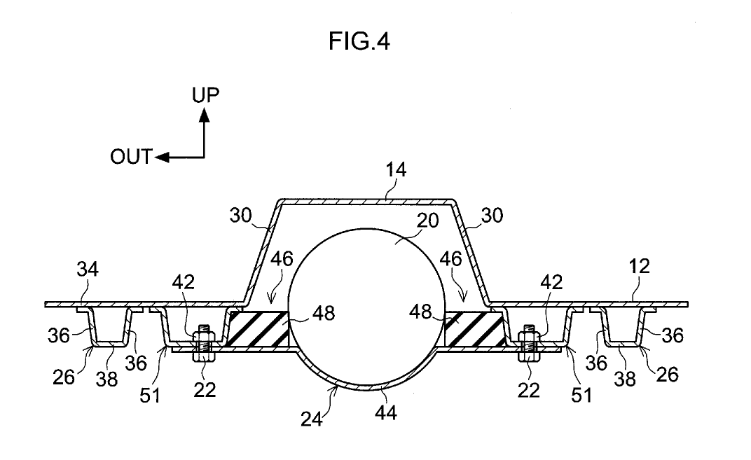

Note that the floor cross member 50 described above is configured joined to the floor reinforcement 26; however configuration is not limited thereto, and as illustrated in FIG. 4, the floor cross member 50 may be only joined to the floor panel 12. In such cases, the tank band 24 is fastened to the floor panel 12 via floor cross members 51, each serving as a protruding section.

Although not'illustrated in the drawings, when assembling the hydrogen tank 20 to the floor panel 12, both the tank bands 24 and the hydrogen tank 20 are lifted toward the vehicle upper side in a state abutting each other, and the hydrogen tank 20 is housed inside the floor tunnel 14 of the floor panel 12 from the vehicle lower side of the floor panel 12. The tank bands 24 and the floor reinforcements 26 (floor cross members 50, 51) are then fastened together by the bolts 22, thereby enabling the hydrogen tank 20 and the tank bands 24 to be attached to the vehicle 10 at the same time.

### Operation and Advantageous Effects of First Exemplary Embodiment

Explanation follows regarding operation and advantageous effects of the first exemplary embodiment.

As illustrated in FIG. 3A, FIG. 3B, in the present exemplary embodiment, each first shock absorbing section 46 is provided between the hydrogen tank 20 housed inside the floor tunnel 14, and the floor reinforcement 26 or the floor cross member 50, 51 (see FIG. 4) attached to the floor panel 12. Generally, in a vehicle side-on collision, when collision load along the vehicle width direction from the vehicle width direction outside is input to the floor panel 12, the floor panel 12 and the floor reinforcement 26 or the floor cross member 50, 51 attached to the floor panel 12 is displaced along the vehicle width direction and abuts the hydrogen tank 20. Impact force from the floor reinforcement 26 or the floor cross member 50, 51 thereby acts on the hydrogen tank 20. However, in the present embodiment, the floor reinforcement 26 or the floor cross member 50, 51 is separated from the hydrogen tank 20 by the first shock absorbing section 46, thereby enabling impact force acting on the hydrogen tank 20 from the floor reinforcement 26 or the floor cross member 50, 51 to be alleviated. This enables an impact resistant structure of the hydrogen tank 20 to be provided by a simple structure. This enables the hydrogen tank 20 to have a lighter weight and a lower cost.

Since the shock absorbing member 48 is provided at the first shock absorbing section 46, impact force acting on the hydrogen tank 20 from the floor reinforcement 26 or the floor cross member 50, 51 in a vehicle side-on collision can be further alleviated. This enables the impact resistant structure of the hydrogen tank 20 to be further improved.

The respective vehicle width direction end portions of the tank bands 24 are fastened to a floor reinforcement 26 or the floor cross member 50, 51 in the vehicle width direction one side, and to the other floor reinforcement 26 or the floor cross member 50, 51 provided at the opposite side in the vehicle width direction, with the hydrogen tank interposed therebetween. Thus, when collision load along the vehicle width direction is input to the floor panel 12 from the vehicle width direction outside in a vehicle side-on collision, collision load is transmitted from one floor reinforcement 26 or floor cross member 50, 51 to the other floor reinforcement 26 or floor cross member 50, 51 through the tank bands 24. This enables collision load acting directly on the hydrogen tank 20 to be reduced.

Since the tank abutting portions 44 that are formed in the same shape as an abutted portion of the outside face of the hydrogen tank 20 support the hydrogen tank 20, the hydrogen tank 20 and the tank abutting portions 44 are in constant contact with each other. This enables the hydrogen tank 20 to be retained in a specific position, and enables the hydrogen tank 20 to be stably supported, thereby enabling the hydrogen tank 20 to be suppressed from vibrating. This enables impact force acting on the hydrogen tank 20 due to vibration to be alleviated, thereby enabling the impact resistant structure of the hydrogen tank 20 to be further improved by a simple structure.

### Second Exemplary Embodiment

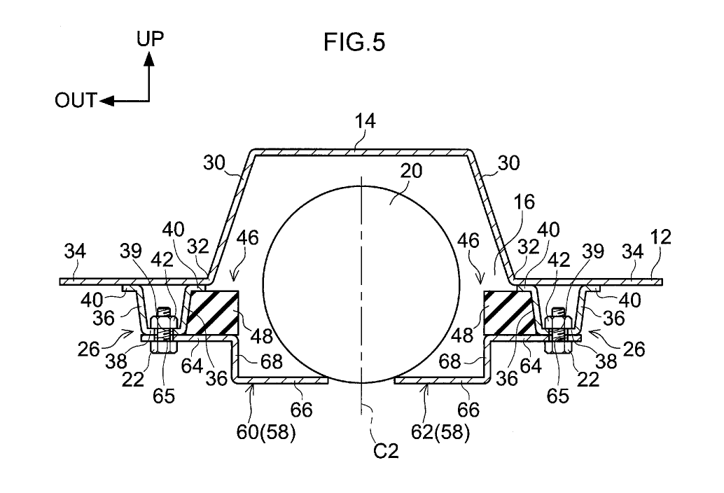

Explanation follows regarding a second exemplary embodiment of a vehicle lower section structure according to the present invention, with reference to FIG. 5. Note that similar configuration portions to the first exemplary embodiment, etc. previously described are appended with the same reference numerals, and explanation thereof is omitted.

A vehicle lower section structure according to the second exemplary embodiment has the same basic configuration as the first exemplary embodiment, with a feature that each tank band 58 is configured as a divided structure.

Namely, the tank band 58 is configured by a first band 60 serving as one band, and a second band 62 serving as another band. Note that the first band 60 and the second band 62 are structures with left-right symmetry along the vehicle width direction about substantially the vehicle width direction center, and so only the one first band 60 is explained with reference to the drawings below.

The first band 60 is configured including a fastening wall portion 64 extending along the vehicle width direction, a tank support wall portion 66 provided at the vehicle lower side of the fastening wall portion 64, and a coupling wall portion 68 that couples between the fastening wall portion 64 and the tank support wall portion 66. The fastening wall portion 64 abuts the reinforcement bottom wall portion 38 of the floor reinforcement 26 from the vehicle lower side. The fastening wall portion 64 is formed with a reinforcement fastening hole 65 piercing through in the plate thickness direction at a position corresponding to the reinforcement fastening hole 39 formed at the reinforcement bottom wall portion 38. The bolt 22 is inserted through the reinforcement fastening hole 39 and the reinforcement fastening hole 65 and fastened by the nut 42, such that the fastening wall portion 64, and accordingly the first band 60, is fastened to the floor panel 12 via the floor reinforcement 26.

A vehicle width direction inside end portion of the fastening wall portion 64 extends toward the vehicle width direction inside as far as substantially the same position as a vehicle width direction inside end portion of the shock absorbing member 48 attached to the floor reinforcement 26. Namely, configuration is such that the fastening wall portion 64 is capable of supporting the shock absorbing member 48 from the vehicle lower side. The shock absorbing member 48 is thereby suppressed from falling toward the vehicle lower side.

The coupling wall portion 68 extends toward the vehicle lower side from the vehicle width direction inside end portion of the fastening wall portion 64. The tank support wall portion 66 extends along the vehicle width direction toward the vehicle width direction inside from a vehicle lower side end portion of the coupling wall portion 68. The tank support wall portion 66 abuts the vehicle lower side of the hydrogen tank 20, and a vehicle width direction inside end portion of the tank support wall portion 66 is configured so as to be positioned further to the vehicle width direction outside than a vehicle width direction center C2 of the hydrogen tank 20. The first band 60 and the second band 62 are thereby attached to the floor reinforcements 26 in a separated state.

### Operation and Advantageous Effects of Second Exemplary Embodiment

Explanation follows regarding operation and advantageous effects of the second exemplary embodiment.

As illustrated in FIG. 5, similarly to in the first exemplary embodiment, in the present exemplary embodiment, each first shock absorbing section 46 is provided between the hydrogen tank 20 housed inside the floor tunnel 14, and the floor reinforcement 26 (floor cross member 50, 51) attached to the floor panel 12. Generally, in a vehicle side-on collision, when collision load along the vehicle width direction from the vehicle width direction outside is input to the floor panel 12, the floor panel 12 and the floor reinforcement 26 (floor cross member 50, 51) attached to the floor panel 12 are displaced along the vehicle width direction and abut the hydrogen tank 20. Impact force from the floor reinforcement 26 or the floor cross member 50, 51 thereby acts on the hydrogen tank 20. However, in the present embodiment, the floor reinforcement 26 (floor cross member 50, 51) is separated from the hydrogen tank 20 by the first shock absorbing section 46, thereby enabling impact force acting on the hydrogen tank 20 from the floor reinforcement 26 (floor cross member 50, 51) to be alleviated. This enables the impact resistant structure of the hydrogen tank 20 to be provided by a simple structure. This enables the hydrogen tank 20 to have a lighter weight and a lower cost.

Since the shock absorbing member 48 is provided at the first shock absorbing section 46, impact force acting on the hydrogen tank 20 from the floor reinforcement 26 or the floor cross member 50, 51 in a vehicle side-on collision can be further alleviated. This enables the impact resistant structure of the hydrogen tank 20 to be further improved.

The tank band 58 is configured such that the first band 60 and the second band 62 are separated from each other, thereby enabling variations in dimensions and variations in assembly of the tank band 58 and the floor panel 12, etc. to be adjustable. This facilitates attachment of the tank band 58 to the vehicle 10, enabling ease of assembly to be improved.

### Third Exemplary Embodiment

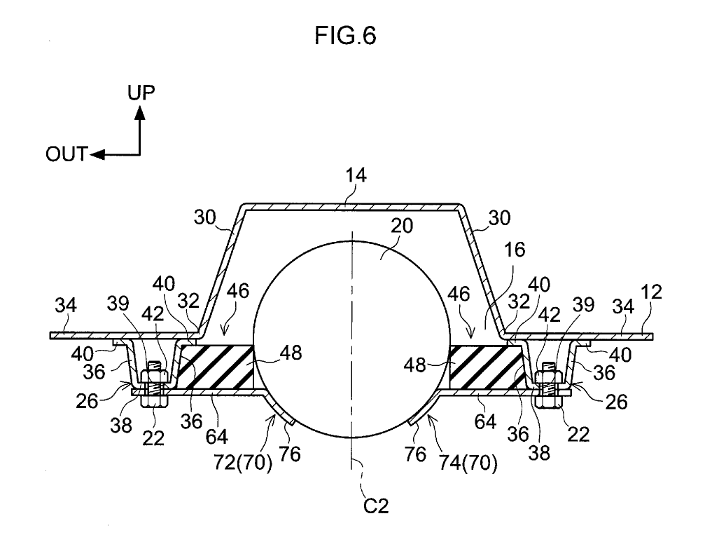

Explanation follows regarding a third exemplary embodiment of a vehicle lower section structure according to the present invention, with reference to FIG. 6. Note that similar configuration portions to the first and second exemplary embodiments, etc. previously described are appended with the same reference numerals, and explanation thereof is omitted.

A vehicle lower section structure according to the third exemplary embodiment has the same basic configuration as the second exemplary embodiment, with a feature that a first band 72 and a second band 74 of a tank band 70 are each configured by the fastening wall portion 64, and a tank support wall portion 76 serving as a tank support portion. Note that the first band 72 and the second band 74 are structures with left-right symmetry along the vehicle width direction about substantially the vehicle width direction center, and so only the one first band 72 is explained with reference to the drawings below.

The first band 72 is configured including the fastening wall portion 64, and the tank support wall portion 76 provided at the vehicle width direction inside end portion of the fastening wall portion 64. The fastening wall portion 64 extends along the vehicle width direction as far as a position where the vehicle width direction inside end portion thereof abuts the hydrogen tank 20. The tank support wall portion 76 is formed in substantially the same shape as the shape of an abutted portion of the outer peripheral face of the hydrogen tank 20.

### Operation and Advantageous Effects of Third Exemplary Embodiment

Explanation follows regarding operation and advantageous effects of the third exemplary embodiment.

As illustrated in FIG. 6, similarly to in the first and second exemplary embodiments, in the present exemplary embodiment, each first shock absorbing section 46 is provided between the hydrogen tank 20 housed inside the floor tunnel 14, and the floor reinforcement 26 (floor cross member 50, 51) attached to the floor panel 12. Generally, in a vehicle side-on collision, when collision load along the vehicle width direction from the vehicle width direction outside is input to the floor panel 12, the floor panel 12 and the floor reinforcement 26 (the floor cross member 50, 51) attached to the floor panel 12 are displaced along the vehicle width direction and abut the hydrogen tank 20. Impact force from the floor reinforcement 26 or the floor cross member 50, 51 thereby acts on the hydrogen tank 20. However, in the present embodiment, the floor reinforcement 26 (floor cross member 50, 51) is separated from the hydrogen tank 20 by the first shock absorbing section 46, thereby enabling impact force acting on the hydrogen tank 20 from the floor reinforcement 26 or the floor cross member 50, 51 to be alleviated. This enables the impact resistant structure of the hydrogen tank 20 to be provided by a simple structure. This enables the hydrogen tank 20 to have a lighter weight and a lower cost.

Since the shock absorbing member 48 is provided at the first shock absorbing section 46, impact force acting on the hydrogen tank 20 from the floor reinforcement 26 or the floor cross member 50, 51 in a vehicle side-on collision can be further alleviated. This enables the impact resistant structure of the hydrogen tank 20 to be further improved.

Since the tank support wall portions 76 of the first band 72 and the second band 74 are formed in the same shape as abutted portions of the outside face of the hydrogen tank 20 and support the hydrogen tank 20, the hydrogen tank 20 and the tank support wall portions 76 are in constant contact with each other. This enables the hydrogen tank 20 to be retained in a specific position, and enables the hydrogen tank 20 to be stably supported, thereby enabling the hydrogen tank 20 to be suppressed from vibrating. This enables impact force acting on the hydrogen tank 20 due to vibration to be alleviated, thereby enabling the impact resistant structure of the hydrogen tank 20 to be improved by a simple structure.

### Fourth Exemplary Embodiment

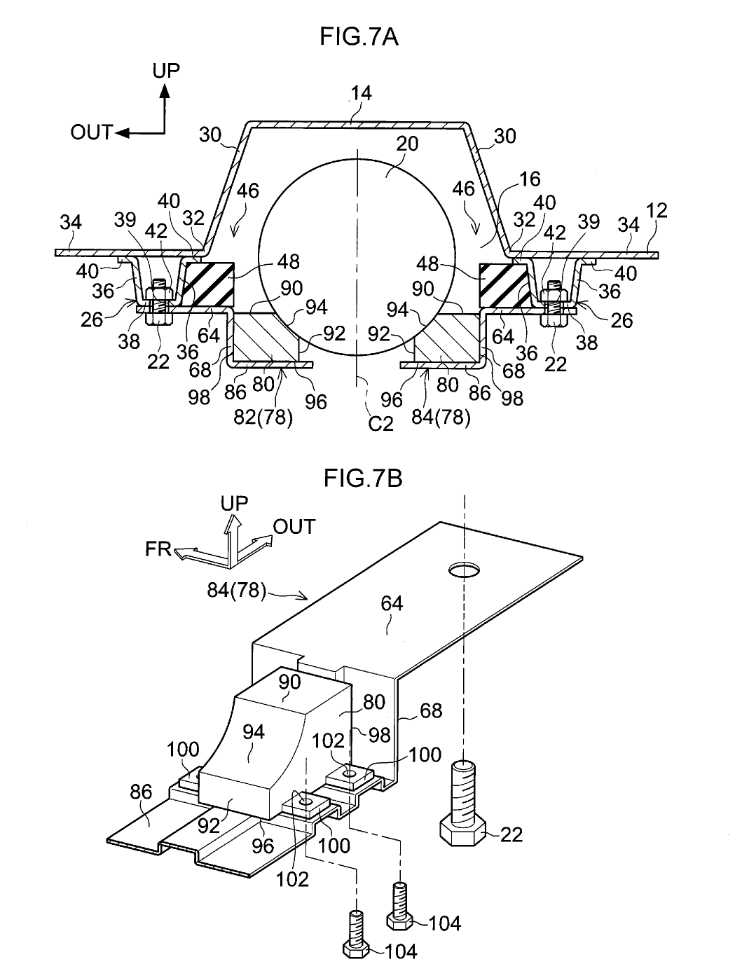

Explanation follows regarding a fourth exemplary embodiment of a vehicle lower section structure according to the present invention, with reference to FIGS. 7A and 7B. Note that similar configuration portions to the first to third exemplary embodiments, etc. previously described are appended with the same reference numerals, and explanation thereof is omitted.

A vehicle lower section structure according to the fourth exemplary embodiment has the same basic configuration as the second exemplary embodiment, with a feature that tank abutting members 80 are provided at tank bands 78.

As illustrated in FIG. 7A, the tank band 78 is configured by a first band 82 and a second band 84. Note that the first band 82 and the second band 84 are structures with left-right symmetry along the vehicle width direction about substantially the vehicle width direction center, and so only the one first band 82 is explained with reference to the drawings below.

The first band 82 is configured including the fastening wall portion 64, a tank support wall portion 86 provided at the vehicle lower side of the fastening wall portion 64, and the coupling wall portion 68 that couples between the fastening wall portion 64 and the tank support wall portion 86.

The coupling wall portion 68 extends toward the vehicle lower side from the vehicle width direction inside end portion of the fastening wall portion 64. The tank support wall portion 86 extends along the vehicle width direction toward the vehicle width direction inside from a vehicle lower side end portion of the coupling wall portion 68. The tank support wall portion 86 is separated from the vehicle lower side of the hydrogen tank 20, and a vehicle width direction inside end portion of the tank support wall portion 86 is configured so as to be positioned further to the vehicle width direction outside than the vehicle width direction center C2 of the hydrogen tank 20.

The tank abutting member 80 is attached to a vehicle upper side face of the tank support wall portion 86. A cross-section profile of the tank abutting member 80 orthogonal to the vehicle front-rear direction is formed in a substantially rectangular shape, with an upper wall portion 90, an inside wall portion 92, a tank abutting portion 94 serving as a tank support portion, a bottom wall portion 96, and an outside wall portion 98.

The tank abutting portion 94 is provided between the upper wall portion 90 provided at the vehicle upper side, and the inside wall portion 92 provided at the vehicle width direction inside. The tank abutting portion 94 abuts the hydrogen tank 20 and is formed in substantially the same shape as an abutted portion of the outer peripheral face of the hydrogen tank 20. The outside wall portion 98 provided at the vehicle width direction outside abuts the coupling wall portion 68, and the bottom wall portion 96 provided at the vehicle lower side abuts the tank support wall portion 86. As illustrated in FIG. 7B, the tank abutting member 80 is provided with attachment tabs 100, each formed in a plate shape. A bolt 104 is inserted through a tab fastening hole 102 piercing through each attachment tab 100 in the plate thickness direction, and a support wall portion fastening hole, not illustrated in the drawings, piercing through the tank support wall portion 86 in the plate thickness direction at a position corresponding to the tab fastening hole 102, and the bolt 104 is fastened by a nut, not illustrated in the drawings. The tank abutting member 80 is thereby fixed to the tank support wall portion 86. Note that in the present exemplary embodiment, the tank abutting member 80 is configured as a structure fastened by the bolts 104; however, configuration is not limited thereto, and a structure may be configured such that the tank abutting member 80 is attached to the tank support wall portion 86 by structural adhesive or the like.

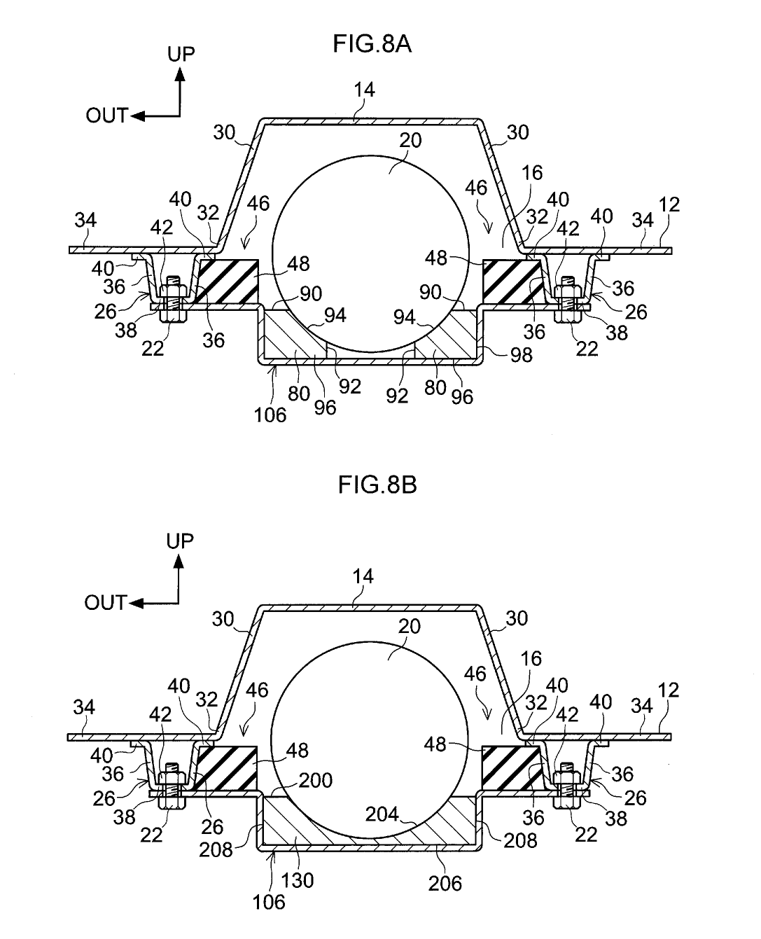

In the present exemplary embodiment, the tank abutting members 80 are provided at the tank band 78 configured as divided structure; however, configuration is not limited thereto, and as illustrated in FIG. 8A, the tank abutting members 80 may be provided at a tank band 106 configured as a single member. In the present exemplary embodiment, configuration is such that one each of tank abutting members 80 are provided so as to have left-right symmetry to each other; however, configuration is not limited thereto, and as illustrated in FIG. 8B, a tank abutting member 130 may be configured as a single member. The tank abutting member 130 is formed by upper wall portions 200, a tank abutting portion 204 serving as a tank support portion, a bottom wall portion 206, and outside wall portions 208. The tank abutting portion 204 abuts the hydrogen tank 20 and is formed in substantially the same shape as an abutted portion of the outer peripheral face of the hydrogen tank 20

### Operation and Advantageous Effects of Fourth Exemplary Embodiment

Explanation follows regarding operation and advantageous effects of the fourth exemplary embodiment.

As illustrated in FIG. 7A, similarly to in the first to third exemplary embodiments, in the present exemplary embodiment, each first shock absorbing section 46 is provided between the hydrogen tank 20 housed inside the floor tunnel 14, and the floor reinforcement 26 (floor cross member 50, 51) attached to the floor panel 12. Generally, in a vehicle side-on collision, when collision load along the vehicle width direction from the vehicle width direction outside is input to the floor panel 12, the floor panel 12 and the floor reinforcement 26 (the floor cross member 50, 51) attached to the floor panel 12 are displaced along the vehicle width direction and abut the hydrogen tank 20. Impact force from the floor reinforcement 26 or the floor cross member 50, 51 thereby acts on the hydrogen tank 20. However, in the present embodiment, the floor reinforcement 26 (floor cross member 50, 51) is separated from the hydrogen tank 20 by the first shock absorbing section 46, thereby enabling impact force acting on the hydrogen tank 20 from the floor reinforcement 26 (floor cross member 50, 51) to be alleviated. This enables the impact resistant structure of the hydrogen tank 20 to be provided by a simple structure. This enables the hydrogen tank 20 to have a lighter weight and a lower cost.

Since the shock absorbing member 48 is provided at the first shock absorbing section 46, impact force acting on the hydrogen tank 20 from the floor reinforcement 26 (floor cross member 50, 51) in a vehicle side-on collision can be further alleviated. This enables the impact resistant structure of the hydrogen tank 20 to be further improved.

Since the tank abutting portions 94, 204 of the tank abutting members 80, 130 that are formed in the same shape as an abutted portion of the outside face of the hydrogen tank 20 support the hydrogen tank 20, the hydrogen tank 20 and the tank abutting portions 94, 204 are in constant contact with each other. This enables the hydrogen tank 20 to be retained in a specific position, and enables the hydrogen tank 20 to be stably supported, thereby enabling the hydrogen tank 20 to be suppressed from vibrating. This enables impact force acting on the hydrogen tank 20 due to vibration to be alleviated, thereby enabling the impact resistant structure of the hydrogen tank 20 to be further improved by a simple structure.

### Fifth Exemplary Embodiment

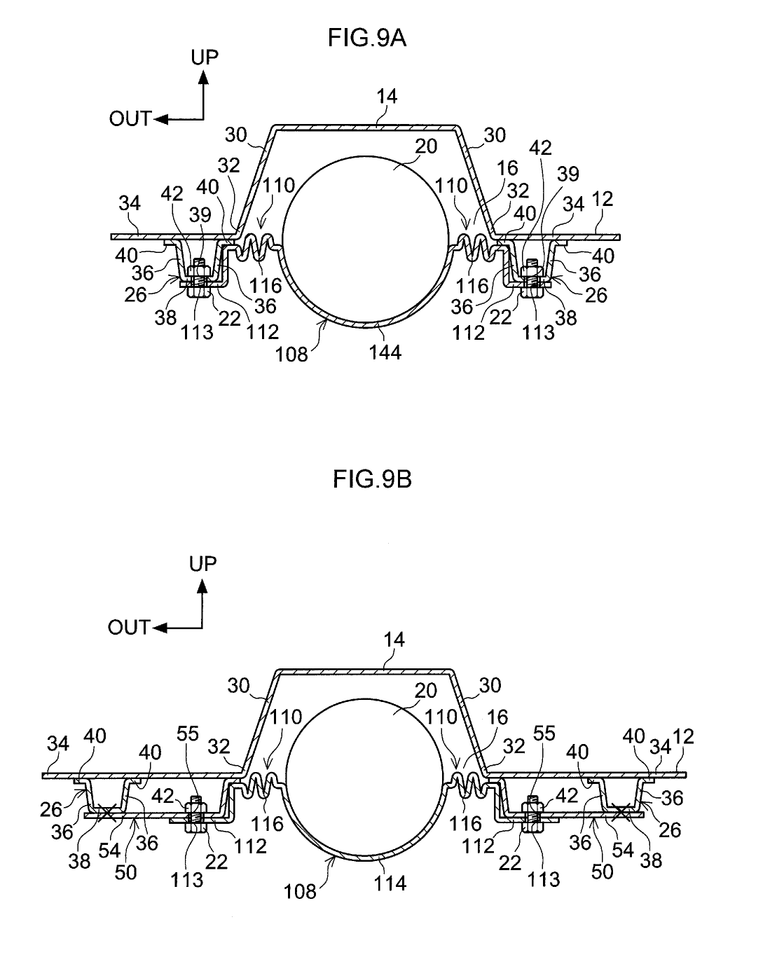

Explanation follows regarding a fifth exemplary embodiment of a vehicle lower section structure according to the present invention, with reference to FIG. 9A and FIG. 9B. Note that similar configuration portions to the first to fourth exemplary embodiments, etc. previously described are appended with the same reference numerals, and explanation thereof is omitted.

A vehicle lower section structure according to the fifth exemplary embodiment has the same basic configuration as the first exemplary embodiment, with a feature that second shock absorbing sections 110 are provided at a tank band 108.

Namely, as illustrated in FIG. 9A, the tank band 108 is configured including fastening wall portions 112, a tank abutting portion 144 provided at the vehicle inside of the fastening wall portions 112, and the second shock absorbing sections 110 that couple between the fastening wall portions 112 and the tank abutting portion 144. Each fastening wall portion 112 abuts the reinforcement bottom wall portion 38 of the floor reinforcement 26 from the vehicle lower side. The fastening wall portion 112 is formed with a band cross fastening hole 113 piercing through in the plate thickness direction at a position corresponding to the reinforcement fastening hole 39 formed at the reinforcement bottom wall portion 38. The bolt 22 is inserted through the reinforcement fastening hole 39 and the band cross fastening hole 113 and fastened by the nut 42, such that the fastening wall portion 112, and accordingly the tank band 108, is fastened to the floor panel 12 via the floor reinforcement 26.

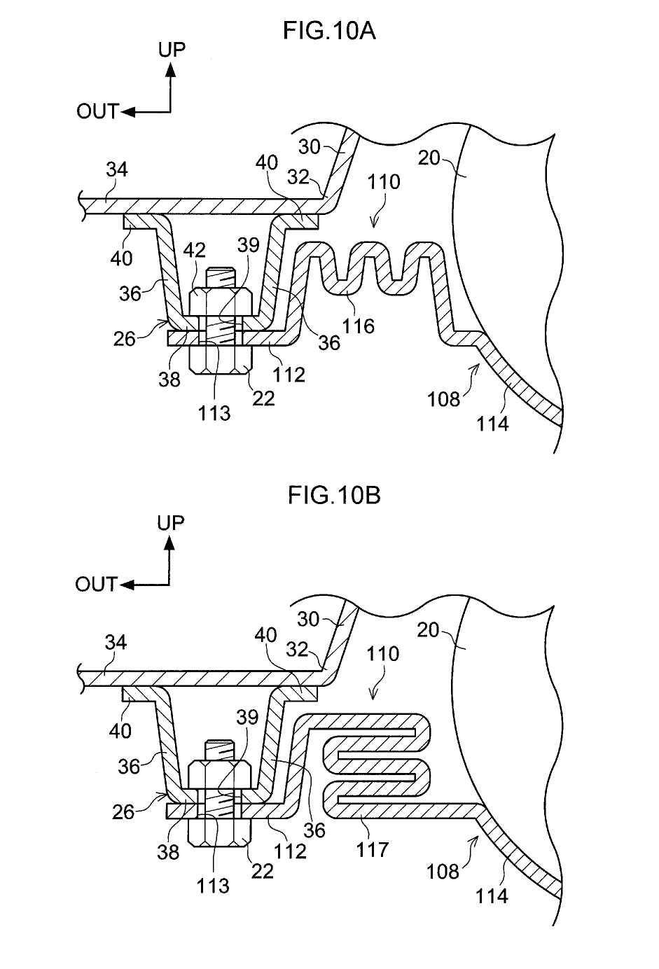

The tank abutting portion 144 abuts the vehicle lower side of the hydrogen tank 20 and is formed in substantially the same shape as an abutted portion of the outer peripheral face of the hydrogen tank 20. Each second shock absorbing section 110 is formed with a stretching and contracting portion 116 that is bent so as to form undulations substantially along the vehicle up-down direction. The fastening wall portion 112 is capable of displacement relative to the tank abutting portion 114 due to the stretching and contracting portion 116. Note that the second shock absorbing section 110 is not limited to a configuration that is bent so as to form undulations substantially along the vehicle up-down direction as illustrated in FIG. 9A, FIG. 9B, and FIG. 10A, and may be configured formed with a stretching and contracting portion 117 that is bent so as to form undulations along the vehicle width direction, as illustrated in FIG. 10B.

As illustrated in FIG. 9B, at a location where the floor cross members 50 are provided, the bolt 22 is inserted through the band cross fastening hole 113 provided piercing through either end portion of the tank band 108 in the plate thickness direction and the member fastening hole 55 of each floor cross member 50, and the bolt 22 is fastened by the nut 42, thereby fastening the tank band 108 to the floor panel 12 via the floor cross member 50.

### Operation and Advantageous Effects of Fifth Exemplary Embodiment

Explanation follows regarding operation and advantageous effects of the fifth exemplary embodiment.

As illustrated in FIG. 9A and FIG. 9B, in the present exemplary embodiment, each second shock absorbing section 110 is provided between the hydrogen tank 20 housed inside the floor tunnel 14, and the floor reinforcement 26 (floor cross member 50, 51) attached to the floor panel 12. Generally, in a vehicle side-on collision, when collision load along the vehicle width direction from the vehicle width direction outside is input to the floor panel 12, the floor panel 12 and the floor reinforcement 26 (the floor cross member 50, 51) attached to the floor panel 12 are displaced along the vehicle width direction and abut the hydrogen tank 20. Impact force from the floor reinforcement 26 or the floor cross member 50, 51 thereby acts on the hydrogen tank 20. However, the present embodiment enables the impact force acting on the hydrogen tank 20 from the floor reinforcement 26 (floor cross member 50, 51) to be alleviated by the second shock absorbing section 110. This enables the impact resistant structure of the hydrogen tank 20 to be formed by a simple structure. This enables the hydrogen tank 20 to have a lighter weight and a lower cost.

Since the tank abutting portion 144 that is formed in the same shape as an abutted portion of the outside face of the hydrogen tank 20 supports the hydrogen tank 20, the hydrogen tank 20 and the tank abutting portion 144 are in constant contact with each other.

This enables the hydrogen tank 20 to be retained in a specific position, and enables the hydrogen tank 20 to be stably supported, thereby enabling the hydrogen tank 20 to be suppressed from vibrating. This enables impact force acting on the hydrogen tank 20 due to vibration to be alleviated, thereby enabling the impact resistant structure of the hydrogen tank 20 to be improved by a simple structure.

### Sixth Exemplary Embodiment

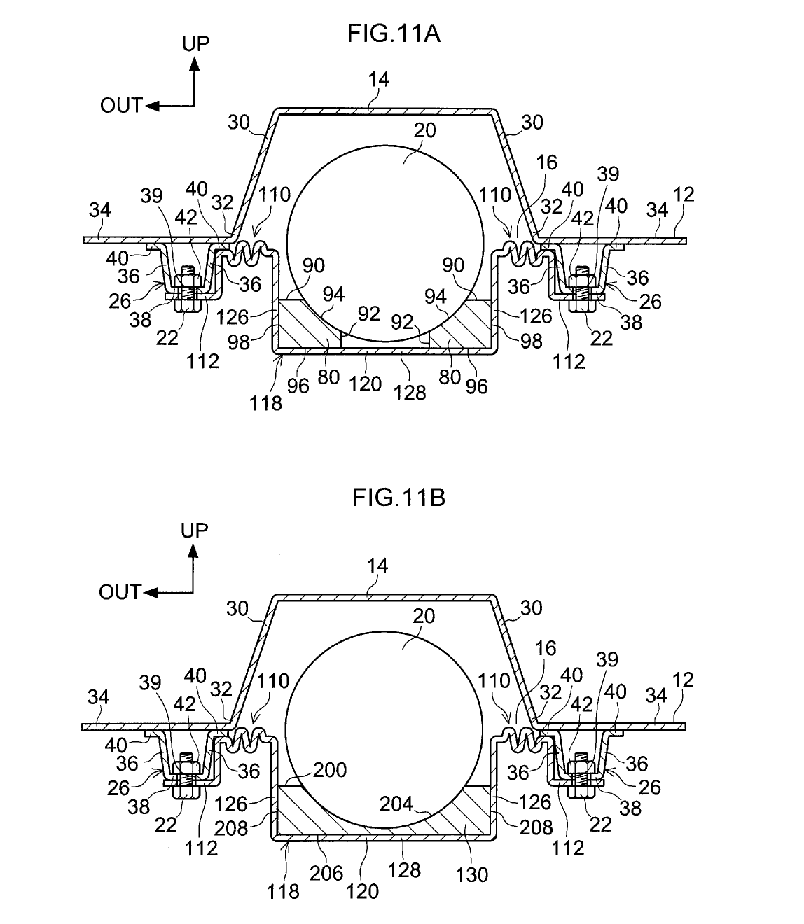

Explanation follows regarding a sixth exemplary embodiment of a vehicle lower section structure according to the present invention, with reference to FIG. 11A and FIG. 11B. Note that similar configuration portions to the first to fifth exemplary embodiments, etc. previously described are appended with the same reference numerals, and explanation thereof is omitted.

A vehicle lower section structure according to the sixth exemplary embodiment has the same basic configuration as the fifth exemplary embodiment, with a feature that tank abutting members 80 are provided at a tank band 118.

Namely, as illustrated in FIG. 11A, the tank band 118 is configured including the fastening wall portions 112, a tank support wall portion 120 provided at the vehicle inside of the fastening wall portions 112, and the second shock absorbing sections 110 that couple the fastening wall portions 112 and the tank support wall portion 120 together. A cross-section profile of the tank support wall portion 120 orthogonal to the vehicle front-rear direction is formed in a substantially U-shape, by a pair of side wall portions 126, and a bottom wall portion 128 that couples together respective vehicle lower side end portions of the side wall portions 126. The tank support wall portion 120 is disposed at a position that is separated from the hydrogen tank 20 at the vehicle lower side thereof.

Two of the tank abutting members 80 are attached to the tank support wall portion 120. Namely, in one tank abutting member 80, the outside wall portion 98 abuts one side wall portion 126, and the bottom wall portion 96 abuts the bottom wall portion 128 and is attached to the tank support wall portion 120. Similarly, in the other tank abutting member 80, the outside wall portion 98 abuts the other side wall portion 126, and the bottom wall portion 96 abuts the bottom wall portion 128 and is attached to the tank support wall portion 120. Namely, the one tank abutting member 80 and the other tank abutting member 80 are disposed with left-right symmetry about the vehicle width direction center of the hydrogen tank 20.

Note that in the present exemplary embodiment, configuration is such that one each of tank abutting members 80 are provided so as to have left-right symmetry to each other; however, configuration is not limited thereto, and as illustrated in FIG. 11B, the tank abutting member 130 may be configured as a single member.

### Operation and Advantageous Effects of Sixth Exemplary Embodiment

Explanation follows regarding operation and advantageous effects of the sixth exemplary embodiment.

As illustrated in FIG. 11A and FIG. 11B, in the present exemplary embodiment, similarly to in the fifth exemplary embodiment, each second shock absorbing section 110 is provided between the hydrogen tank 20 housed inside the floor tunnel 14, and the floor reinforcement 26 (floor cross member 50, 51) attached to the floor panel 12. Generally, in a vehicle side-on collision, when collision load along the vehicle width direction from the vehicle width direction outside is input to the floor panel 12, the floor panel 12 and the floor reinforcement 26 (the floor cross member 50, 51) attached to the floor panel 12 are displaced along the vehicle width direction and abut the hydrogen tank 20. Impact force from the floor reinforcement 26 or the floor cross member 50, 51 thereby acts on the hydrogen tank 20. However, the present embodiment enables the impact force acting on the hydrogen tank 20 from the floor reinforcement 26 (floor cross member 50, 51) to be alleviated by the second shock absorbing section 110. This enables the impact resistant structure of the hydrogen tank 20 to be formed by a simple structure. This enables the hydrogen tank 20 to have a lighter weight and a lower cost.

Since the tank abutting portions 94, 204 of the tank abutting members 80, 130 that are formed in the same shape as abutted portions of the outside face of the hydrogen tank 20 support the hydrogen tank 20, the hydrogen tank 20 and the tank abutting portions 94, 204 are in constant contact with each other. This enables the hydrogen tank 20 to be retained in a specific position, and enables the hydrogen tank 20 to be stably supported, thereby enabling the hydrogen tank 20 to be suppressed from vibrating. This enables impact force acting on the hydrogen tank 20 due to vibration to be alleviated, thereby enabling the impact resistant structure of the hydrogen tank 20 to be improved by a simple structure.

### Seventh Exemplary Embodiment

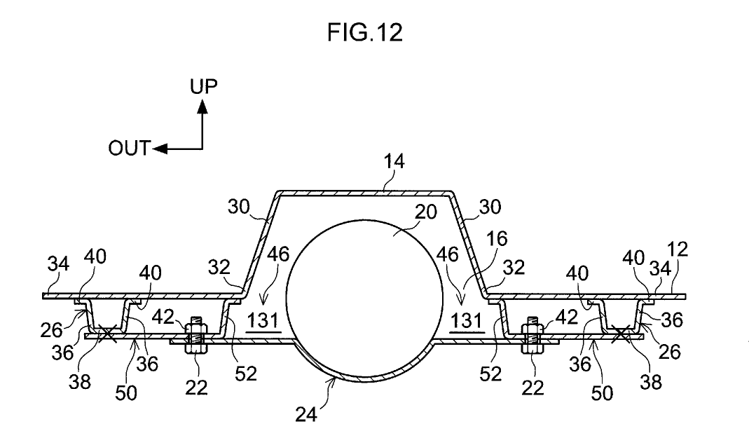

Explanation follows regarding a seventh exemplary embodiment of a vehicle lower section structure according to the present invention, with reference to FIG. 12. Note that similar configuration portions to the first to sixth exemplary embodiments, etc. previously described are appended with the same reference numerals, and explanation thereof is omitted.

A vehicle lower section structure according to the seventh exemplary embodiment has the same basic configuration as the first exemplary embodiment, with a feature that a shock absorbing space 131 is provided at each first shock absorbing section 46.

Namely, as illustrated in FIG. 12, each first shock absorbing section 46 is provided between the member upright wall portion 52 at the vehicle inside of the floor cross member 50 at a location at which the tank bands 24 are provided, and the outside face of the hydrogen tank 20. A space is made by providing the shock absorbing space 131 at the first shock absorbing section 46. Note that the location is not limited to the location where the tank bands 24 are attached to the floor cross member 50, and the shock absorbing space 131 may be provided at the first shock absorbing section 46 at a location where the tank bands 24 are attached to the floor reinforcement 26.

### Operation and Advantageous Effects of Seventh Exemplary Embodiment

Explanation follows regarding operation and advantageous effects of the seventh exemplary embodiment.

As illustrated in FIG. 12, in the present exemplary embodiment, each first shock absorbing section 46 is provided between the hydrogen tank 20 housed inside the floor tunnel 14, and the floor cross member 50, 51 (floor reinforcement 26) attached to the floor panel 12. Generally, in a vehicle side-on collision, when collision load along the vehicle width direction from the vehicle width direction outside is input to the floor panel 12, the floor panel 12 and the floor cross member 50, 51 (floor reinforcement 26) attached to the floor panel 12 are displaced along the vehicle width direction and abut the hydrogen tank 20. Impact force from the floor cross member 50, 51 (floor reinforcement 26) thereby acts on the hydrogen tank 20. However, in the present exemplary embodiment, the floor cross member 50, 51 (floor reinforcement 26) is separated from the hydrogen tank 20 by the first shock absorbing section 46, thereby enabling impact force acting on the hydrogen tank 20 from the floor cross member 50, 51 (floor reinforcement 26) to be alleviated. This enables the impact resistant structure of the hydrogen tank 20 to be formed by a simple structure. This enables the hydrogen tank 20 to have a lighter weight and a lower cost.

The respective vehicle width direction end portions of the tank bands 24 are fastened to one floor cross member 50 (floor reinforcement 26, floor cross member 51) in the vehicle width direction, and to the other floor cross member 50 (floor reinforcement 26, floor cross member 51) provided at the opposite side. Thus, when collision load along the vehicle width direction is input to the floor panel 12 from the vehicle width direction outside in a vehicle side-on collision, collision load is transmitted from one floor cross member 50 (floor reinforcement 26, floor cross member 51) to the other floor cross member 50 (floor reinforcement 26, floor cross member 51) through the tank bands 24. This enables collision load acting directly on the hydrogen tank 20 to be reduced.

Note that in the present exemplary embodiment, each tank band 24 is configured as a single component; however, configuration is not limited thereto, and configuration may be applied with a separated structure. Moreover, a configuration may be applied in which the tank abutting member 80 is provided at the tank bands 24.

### Eighth Exemplary Embodiment

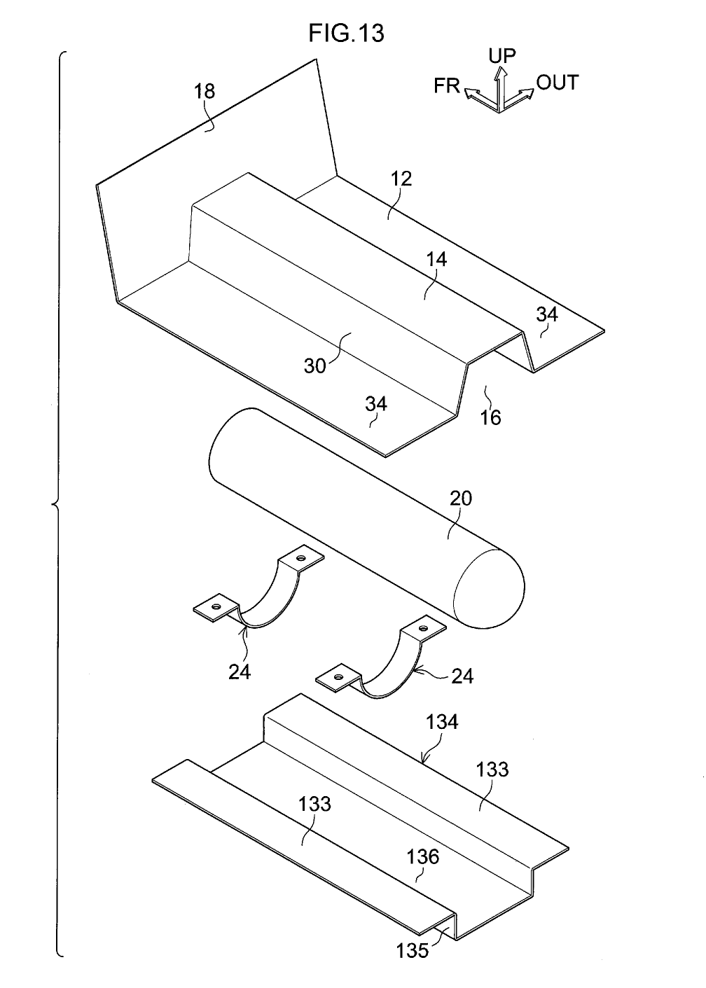

Explanation follows regarding an eighth exemplary embodiment of a vehicle lower section structure according to the present invention, with reference to FIG. 13 to FIGS. 15. Note that similar configuration portions to the first to seventh exemplary embodiments, etc. previously described are appended with the same reference numerals, and explanation thereof is omitted.

A vehicle lower section structure according to the eighth exemplary embodiment is a supplementary configuration to the first to seventh exemplary embodiments, with a feature that a tank protection plate 134 is provided at the vehicle lower side of the hydrogen tank 20.

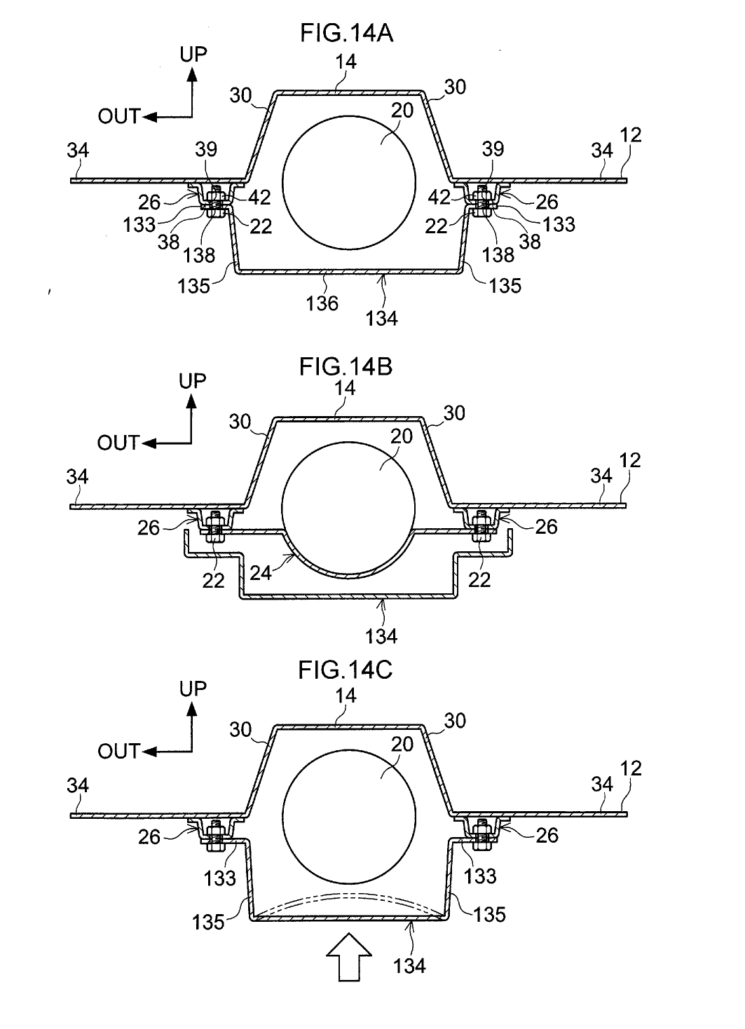

Namely, as illustrated in FIG. 13, the tank protection plate 134 is provided at the vehicle lower side of the hydrogen tank 20 that is attached to the floor panel 12 by the tank bands 24. The tank protection plate 134 includes a pair of protection panel side wall portions 135, a protection panel bottom wall portion 136 that couples together respective vehicle lower side end portions of the protection panel side wall portions 135, and protection panel flange portions 133 that extend from vehicle upper side end portions of the protection panel side wall portions 135, so as to separate from each other along the vehicle width direction. A cross-section profile of the tank protection plate 134 orthogonal to the vehicle front-rear direction thereby configures a hat shape. As illustrated in FIG. 14A, each protection panel flange portion 133 of the tank protection plate 134 abuts the reinforcement bottom wall portion 38 of the floor reinforcement 26 from the vehicle lower side. The bolt 22 is inserted through the reinforcement fastening hole 39 of the reinforcement bottom wall portion 38, and a protection panel fastening hole 138 formed piercing through the protection panel flange portion 133 in the plate thickness direction, and the bolt 22 is fastened to the nut 42. The protection panel flange portion 133 is thereby attached to the floor reinforcement 26, and accordingly to the floor panel 12. Note that, as illustrated in FIG. 14B, at a location where the tank band 24 is attached, each protection panel flange portion 133 of the tank protection plate 134 is bent so as to cover the tank band 24, and the bolt 22 that fastens the tank band 24 to the floor reinforcement 26, from the vehicle lower side.

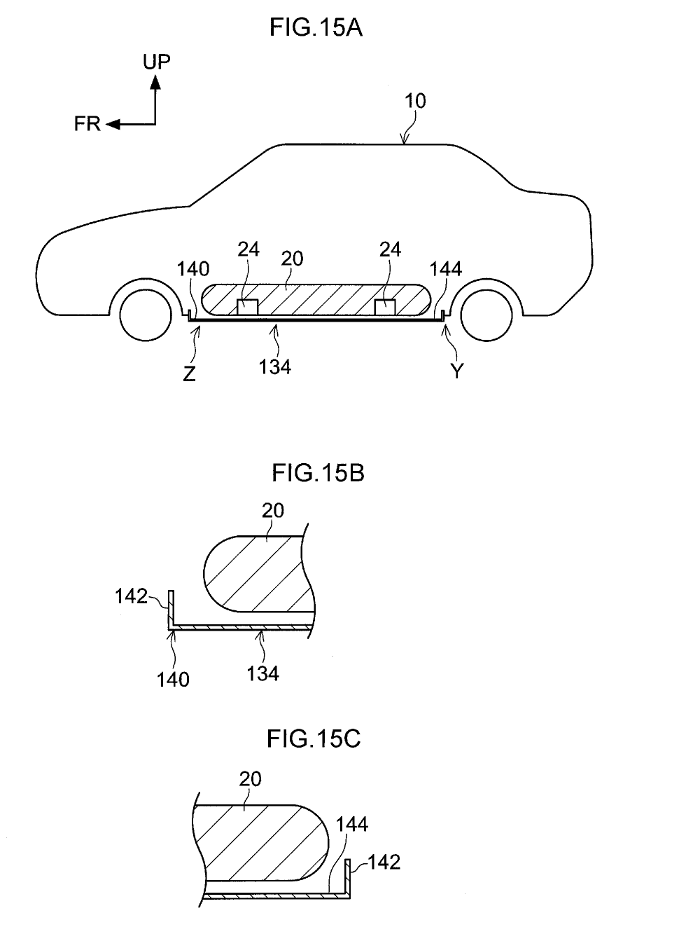

As illustrated in FIG. 15B, a raised portion 142 is formed at a front end portion 140 of the tank protection plate 134. The raised portion 142 extends along the vehicle up-down direction toward the vehicle upper side from the front end portion 140 and is separated from a front end portion of the hydrogen tank 20. Thus, in cases in which collision load is input from the vehicle front side, the raised portion 142 bears the collision load, thereby enabling the impact acting on the hydrogen tank 20 to be alleviated. Moreover, as illustrated in FIG. 15C, a raised portion 142 is also formed at a rear end portion 144 of the tank protection plate 134, similarly to at the front end portion 140 of the tank protection plate 134. Thus, in cases in which collision load is input from the vehicle rear side, the raised portion 142 bears the collision load, thereby enabling the impact acting on the hydrogen tank 20 to be alleviated.

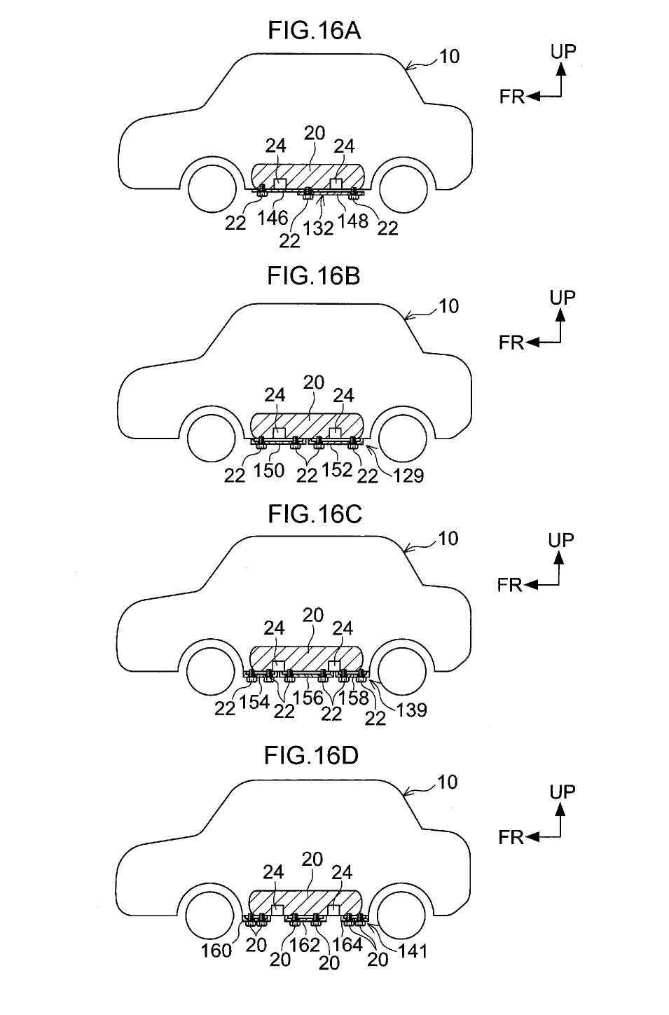

The tank protection plate 134 is not limited to a configuration in which the hydrogen tank 20 is covered from the vehicle lower side by a single member, and as illustrated by a first to a fourth modified example illustrated in FIG. 16A to FIG. 16D, a configuration of plural members may be applied. Namely, a tank protection plate 132 of the first modified example illustrated in FIG. 16A is configured by a first front side protection panel 146 and a first rear side protection panel 148. The first front side protection panel 146 and the first rear side protection panel 148 are fastened to the floor reinforcements 26, or the like by the bolts 22, in a state in which a rear end portion of the first front side protection panel 146 and a front end portion of the first rear side protection panel 148 overlap each other. Namely, configuration is such that the entire lower face of the hydrogen tank 20, including the tank bands 24, is covered. This enables the respective sizes of the first front side protection panel 146 and the first rear side protection panel 148 to be smaller than in cases of configuration by a single panel, thereby facilitating handling when assembling the tank protection plate 132, and enabling the hydrogen tank 20 to be reliably protected.

A tank protection plate 129 of the second modified example illustrated in FIG. 16B is configured by a second front side protection panel 150 and a second rear side protection panel 152. The second front side protection panel 150 and the second rear side protection panel 152 are fastened to the floor reinforcements 26, or the like by the bolts 22, in a state in which a rear end portion of the second front side protection panel 150 and a front end portion of the second rear side protection panel 152 face each other. This enables the respective sizes of the second front side protection panel 150 and the second rear side protection panel 152 to be smaller than in cases of configuration by a single panel, thereby facilitating handling when assembling the tank protection plate 129, and facilitating the attachment operation.

A tank protection plate 139 of the third modified example illustrated in FIG. 16C is configured by a third front side protection panel 154, a third intermediate protection panel 156, and a third rear side protection panel 158. The third front side protection panel 154 and the third intermediate protection panel 156 are fastened to the floor reinforcements 26, or the like by the bolts 22, in a state in which a rear end portion of the third front side protection panel 154, and a front end portion of the third intermediate protection panel 156 face each other at the vehicle lower side of the tank band 24 that is provided at a vehicle front side. The third intermediate protection panel 156 and the third rear side protection panel 158 are fastened to the floor reinforcements 26, or the like by the bolts 22, in a state in which a rear end portion of the third intermediate protection panel 156, and a front end portion of the third rear side protection panel 158 face each other at the vehicle lower side of the tank band 24 that is provided at a vehicle rear side. Namely, this enables the respective individual sizes of the third front side protection panel 154, the third intermediate protection panel 156, and the third rear side protection panel 158 to be made smaller, in a configuration in which substantially the entire lower face of the hydrogen tank 20, including the tank bands 24, is covered. This further facilitates handling when assembling the tank protection plate 139, and enables the hydrogen tank 20 to be reliably protected.

A tank protection plate 141 of the fourth modified example illustrated in FIG. 16D is configured by a fourth front side protection panel 160, a fourth intermediate protection panel 162, and a fourth rear side protection panel 164. The fourth front side protection panel 160 and the fourth intermediate protection panel 162 are fastened to the floor reinforcements 26, or the like by the bolts 22 at the vehicle lower side of the tank band 24, in a state in which the tank band 24 is interposed between a rear end portion of the fourth front side protection panel 160 and a front end portion of the fourth intermediate protection panel 162. The fourth intermediate protection panel 162 and the fourth rear side protection panel 164 are fastened to the floor reinforcements 26, or the like by the bolts 22 at the vehicle lower side of the tank band 24, in a state in which the tank band 24 is interposed between a rear end portion of the fourth intermediate protection panel 162 and a front end portion of the fourth rear side protection panel 164. This suppresses the surface of the hydrogen tank 20 from being exposed at the vehicle exterior, and enables the respective individual sizes of the fourth front side protection panel 160, the fourth intermediate protection panel 162, and the fourth rear side protection panel 164 to be made even smaller. This further facilitates handling when assembling the tank protection plate 141, and further facilitates the attachment operation.

### Operation and Advantageous Effects of Eighth Exemplary Embodiment

Explanation follows regarding operation and advantageous effects of the eighth exemplary embodiment.

As illustrated in FIG. 14A, in the present exemplary embodiment, the hydrogen tank 20 is covered from the vehicle lower side by the tank protection plate 134, such that, as illustrated in FIG. 14C, impact force input to the vehicle 10 from below the vehicle by an obstacle or the like is input to the tank protection plate 134. Namely, not only during a vehicle side-on collision, impact force from below the vehicle can also be alleviated by the tank protection plate 134 without being directly transmitted to the hydrogen tank 20. This enables the impact acting on the hydrogen tank 20 to be further alleviated.

### Ninth Exemplary Embodiment

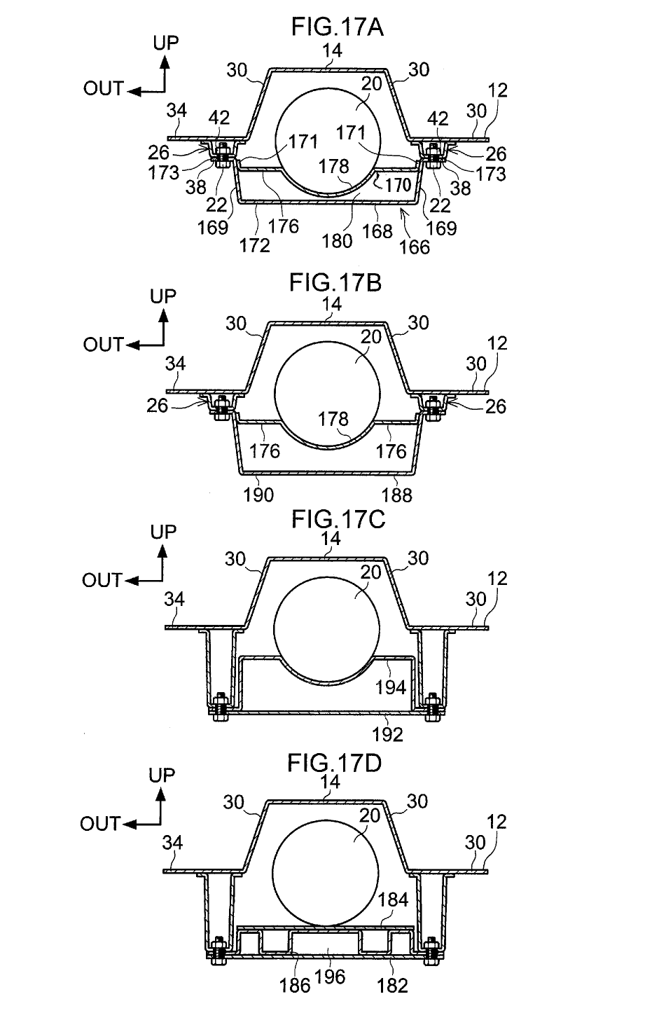

Explanation follows regarding a ninth exemplary embodiment of a vehicle lower section structure according to the present invention, with reference to FIG. 17A to FIG. 17D. Note that similar configuration portions to the first to eighth exemplary embodiments, etc. previously described are appended with the same reference numerals, and explanation thereof is omitted

A vehicle lower section structure according to the ninth exemplary embodiment has the same basic configuration as the eighth exemplary embodiment, with a feature that a tank protection plate 166 includes plural plates in the vehicle up-down direction.

Namely, as illustrated in FIG. 17A, the tank protection plate 166 is configured by a first outer panel 168 serving as an outer panel, and a first inner panel 170 serving as an inner panel. The first outer panel 168 includes a pair of outer side wall portions 169, an outer bottom wall portion 172 that couples together respective vehicle lower side end portions of the outer side wall portions 169, and outer flange portions 173 that extend from vehicle upper side end portions of the outer side wall portions 169, so as to separate from each other along the vehicle width direction. A cross-section profile of the first outer panel 168 orthogonal to the vehicle front-rear direction is thereby formed in a hat shape. Each outer flange portion 173 of the first outer panel 168 abuts the reinforcement bottom wall portion 38 of the floor reinforcement 26 from the vehicle lower side. The bolt 22 is inserted through the reinforcement fastening hole 39 of the reinforcement bottom wall portion 38, and an outer fastening hole, not illustrated in the drawings, piercing through the outer flange portion 173 in the plate thickness direction, and the bolt 22 is fastened to the nut 42. The outer flange portion 173 is thereby attached to the floor reinforcement 26, and accordingly to the floor panel 12.

The first inner panel 170 includes a pair of inner side wall portions 171, an inner bottom wall portion 176 that couples together respective vehicle lower side end portions of the inner side wall portions 171 and extends along the vehicle width direction, and a tank abutting portion 178 serving as a tank support portion that is formed at the vehicle width direction central portion of the inner bottom wall portion 176. A cross-section profile of the first inner panel 170 orthogonal to the vehicle front-rear direction is thereby formed in substantially a U-shape. Each inner side wall portion 171 is joined to a vehicle width direction inside face of the outer side wall portion 169, such that the first inner panel 170 and the first outer panel 168 are configured as an integral unit. The tank abutting portion 178 has substantially the same shape as an abutted portion of the shape of the outer peripheral face of the hydrogen tank 20.

A deformation absorption section 180 is provided between the first inner panel 170 and the first outer panel 168. The deformation absorption section 180 is a space surrounded by the pair of outer side wall portions 169, the outer bottom wall portion 172, the inner bottom wall portion 176, and the tank abutting portion 178. Note that the size of the deformation absorption section 180 may be modified as appropriate. For example, as in a first modified example illustrated in FIG. 17B, a modified shape may be applied in which an outer bottom wall portion 190 of a first outer panel 188 is moved toward the vehicle lower side. As in a second modified example illustrated in FIG. 17C, a first outer panel 192 may be formed in a flat plate shape, and a first inner panel 194 formed in substantially a hat shape.

As illustrated in FIG. 17A, in the present exemplary embodiment, the tank protection plate 166 is configured by two components, these being the first inner panel 170 and the first outer panel 168; however, configuration is not limited thereto. As illustrated in a modified example in FIG. 17D, configuration may be made by three components, these being a second outer panel 182, a second inner panel 184 that abuts the hydrogen tank 20, and a second intermediate member 186 that is provided between the second outer panel 182 and the second inner panel 184 and includes protruding shapes toward the vehicle upper side. In such cases, a space 196 formed by the second intermediate member 186 configures a deformation absorption section. The tank protection plate 166 may also be configured by more than three components.

### Operation and Advantageous Effects of Ninth Exemplary Embodiment

Explanation follows regarding operation and advantageous effects of the ninth exemplary embodiment.

As illustrated in FIG. 17A, in the present exemplary embodiment, the deformation absorption section 180 is provided between the hydrogen tank 20 and the tank protection plate 166. Thus, even if the tank protection plate 166 deforms so as to project out toward the vehicle upper side due to impact force input to the vehicle 10 from below the vehicle by an obstacle or the like, the tank protection plate 166 and the hydrogen tank 20 are suppressed from abutting each other, thereby enabling the impact force acting on the hydrogen tank 20 from the tank protection plate 166 to be alleviated.

Since the tank abutting portion 178 that is formed in the same shape as an abutted portion of the outside face of the hydrogen tank 20 supports the hydrogen tank 20, the hydrogen tank 20 and the tank abutting portion 178 are in constant contact with each other. This enables the hydrogen tank 20 to be retained in a specific position, and enables the hydrogen tank 20 to be stably supported, thereby enabling the hydrogen tank 20 to be suppressed from vibrating. This enables impact force acting on the hydrogen tank 20 due to vibration to be alleviated, thereby enabling the impact resistant structure of the hydrogen tank 20 to be improved by a simple structure.

Note that in the first to ninth exemplary embodiments described above, the hydrogen tank 20 that stores hydrogen internally is given as an example of a tank; however, configuration is not limited thereto, and the tank may be a gas tank that stores gas, or a tank that stores another substance.

Exemplary embodiments of the present invention have been explained above; however, the present invention is not limited to the above, and obviously various other modifications may be implemented within a range not departing from the scope of the present invention.

1. A vehicle lower section structure comprising:
a floor tunnel that extends along a vehicle front-rear direction at substantially a vehicle width direction center of a floor panel and that is open toward a vehicle lower side;
protruding sections that are attached to the floor panel, that extend along the vehicle front-rear direction or the vehicle width direction, and that project out toward the vehicle lower side;
at least one tank band fastened to the protruding sections;
a tank that is retained by at least one tank band in a state in which an upper portion of the tank is housed inside the floor tunnel; and
shock absorbing sections that are provided between the respective protruding sections and a lower portion of the tank, and each of that is configured to alleviate impact force acting on the tank from any one of the protruding sections that is displaced in the vehicle width direction due to collision load from a vehicle side direction,
wherein the shock absorbing sections are spaces; and
a shock absorbing member is disposed at both sides in the vehicle width direction of the tank in the shock absorbing sections and is not disposed at the upper portion of the tank that is housed inside the floor tunnel.

2. The vehicle lower section structure of claim 1, wherein each of the shock absorbing sections is provided with the shock absorbing member that absorbs the impact force.

3. The vehicle lower section structure of claim 1, wherein:
the at least one tank band includes a plurality of tank bands, and
one end portion of each of the plurality of tank bands is fastened to one of the protruding sections, and the plurality of tank bands installed separated from each other.

4. A vehicle lower section structure comprising:
a floor tunnel that extends along a vehicle front-rear direction at substantially a vehicle width direction center of a floor panel and that is open toward a vehicle lower side;
protruding sections that are attached to the floor panel, that extend along the vehicle front-rear direction or the vehicle width direction, and that project out toward the vehicle lower side;
at least one tank band fastened to the protruding sections;
a tank that is retained by the at least one tank band in a state in which an upper portion of the tank is housed inside the floor tunnel; and
another shock absorbing section that is integrally formed with a portion of the at least one tank band, and that is configured to alleviate impact force acting on the tank from any one of the protruding sections that is displaced in the vehicle width direction due to collision load from a vehicle side direction,
wherein the shock absorbing sections are spaces; and
a shock absorbing member is disposed at both sides in the vehicle width direction of the tank in the shock absorbing sections and is not disposed at the upper portion of the tank that is housed inside the floor tunnel.

5. The vehicle lower section structure of claim 1, wherein the at least one tank band is provided with a tank support portion that abuts the tank and that is formed in substantially a same shape as an outside face of the tank at a location the tank support portion abuts the tank.

6. The vehicle lower section structure of claim 4, wherein the at least one tank band is provided with a tank support portion that abuts the tank and that is formed in substantially same shape as an outside face of the tank at the abutted location.

7. The vehicle lower section structure of claim 1, wherein a tank protection plate formed in a plate shape is provided at the vehicle lower side of the tank and the at least one tank band so as to cover the tank from at least the vehicle lower side.

8. The vehicle lower section structure of claim 4, wherein a tank protection plate formed in a plate shape is provided at the vehicle lower side of the tank and the at least one tank band so as to cover the tank from at least the vehicle lower side.

9. The vehicle lower section structure of claim 7, wherein the tank protection plate is configured by an inner panel that supports the tank, and an outer panel that is disposed separated from the inner panel at the vehicle lower side of the inner panel.

10. The vehicle lower section structure of claim 8, wherein the tank protection plate is configured by an inner panel that supports the tank, and an outer panel that is disposed separated from the inner panel at the vehicle lower side of the inner panel.

11. The vehicle lower section structure of claim 1, further comprising a tank support member that is provided between the tank band and the tank,
wherein the tank support member is formed with a tank support portion that abuts the tank and is formed in substantially a same shape as an outside face of the tank at the abutted location.

12. The vehicle lower section structure of claim 4, further comprising a tank support member that is provided between the at least one tank band and the tank,
wherein the tank support member is formed with a tank support portion that abuts the tank and is formed in substantially a same shape as an outside face of the tank at the abutted location.
